(19) United States
(12) Patent Application Publication
(10) Pub. No.: US 2012/0039599 A1
(43) Pub. Date: Feb. 16, 2012

(54) METHOD AND SYSTEM FOR TRACKING TWO COMMUNICATIONS PARTICIPANTS OF AN OPTICAL SATELLITE COMMUNICATIONS SYSTEM

(75) Inventor: Jens VON SCHWAKE, Neubiberg (DE)

(73) Assignee: ASTRIUM GMBH, Taufkirchen (DE)

(21) Appl. No.: 13/206,929

(22) Filed: Aug. 10, 2011

(30) Foreign Application Priority Data
Aug. 11, 2010 (DE) 102010034065.0

(51) Int. Cl. H04B 10/08

(52) U.S. Cl. 398/25

(57) ABSTRACT

Method and system for tracking between two communications participants of an optical satellite communications system to provide a communication connection between the two communications participants. The method includes transmitting a signal from a first of the two communications participants to a second of the two communications participants, in which the second communications participant includes a detector arrangement with a plurality of detectors in a common receiving plane. The method also includes acquiring a phase of the signal at each of the plurality of detectors and determining phase differences between the phases via a phase-processor, determining from the phase differences a phase angle of an alignment of the signal to the receiving plane, processing the phase angle with a tracking computer in order to align the receiving plane of the second communications participant with the signal, whereby the phase difference becomes zero, and continuously calibrating the plurality of detectors of the detector arrangement.

### CROSS-REFERENCE TO RELATED APPLICATIONS

The present application claims priority under 35 U.S.C. §119 of German Patent Application No. DE 10 2010 034 065.0, filed on Aug. 11, 2010, the disclosure of which is expressly incorporated by reference herein in its entirety.

### BACKGROUND OF THE INVENTION

1. Field of the Invention

The invention relates to a method and a system for tracking two communications participants of an optical satellite communications system, in particular of a satellite and a ground station, to provide an optical communication connection between the two communications participants.

2. Discussion of Background Information

With so-called intersatellite link (ISL) communication based on data transmission technologies in the optical range between LEO (Low Earth Orbit) satellites and ground stations or GEO satellites and ground stations, on-off keying (OOK) is typically used as a modulation method. The referenced ISL communication is usually based on an optical data signal with a wavelength of 1550 nm. B-PSK (binary phase-shift keying) has also recently been used as a modulation method in addition to OOK within the scope of satellite communication.

For communication with the aid of optical transmission methods and techniques, such as laser terminals of two communications participants, it is particularly necessary for their transmitter and receiver devices to be aligned very exactly to one another. For tracking the communications participants, i.e., their antennas, calculated position data of the ground station and the satellite can be used, for example. Usually a sensor provided in the satellite or the ground station, a so-called 4-quadrant sensor in connection with an FPA plane for detecting the maximum amplitude of an additional tracking or beacon signal, of a so-called beacon, is also used for tracking, which signal is emitted by the respective outstation. The continuous tracking is generally referred to as tracking. Within the scope of the communication, the satellite typically represents a transmitter and the ground station represents a receiver. The receiver, i.e., the ground station, is aligned to the transmitter, i.e., the satellite, according to the information obtained.

One disadvantage of the tracking method based on the evaluation of amplitude maxima is the lack of accuracy. This results among other things from the fact that the optical communication used as well as the OOK and PSK modulation methods thereof used are subject to atmospheric influences. In order to be able to realize a tracking method based on an optical communication connection over long distances of, for example, more than 100,000 km or even so-called deep space communication, optical connections with smaller beam widths are necessary. However, this requires an improved tracking method.

A method is known from the Patent Abstracts of Japan, JP 11014727, in which a communications participant transmits a conventional HF signal to another communications participant. The other communications participant comprises an antenna arrangement with several antennas, by which respectively one phase of the signal is detected. A phase difference between the phases received by the antennas is determined from the phases. A phase angle of the alignment of the signal to the receiving plane is determined from the phase difference. The phase angle is changed by a change in the alignment of the receiving communications participant, such that the phase difference becomes zero.

### SUMMARY OF THE INVENTION

Embodiments of the present invention relate to a method and a system with which an improved tracking performance of two communications participants of an optical satellite communications system is achieved.

According to the embodiments, the method includes that a first of the two communications participants transmits a signal to a second of the two communications participants, and the second communications participant includes a detector arrangement with several detectors in a common receiving plane, by which respectively the phase of the signal is acquired, so that phase differences between the phases are determined by a phase-processing unit. A phase angle of the alignment of the signal to the receiving plane is determined from the phase differences, and the phase angle is processed by a tracking computer, in order to align the receiver unit of the respective communications participant to the signal so that the phase difference becomes zero. The detectors of the detector arrangement are continuously calibrated. Further, the system includes a first of the two communications participants that includes a transmitter unit with which a signal can be transmitted to a second of the two communications participants, and the second communications participant includes a detector arrangement with several detectors in a common receiving plane, through which respectively the phase of the signal can be detected. The second communications participant includes a phase-processing unit and a phase angle determining unit, wherein phase differences between the phases can be determined by the phase-processing unit and a phase angle of the alignment of the signal to the receiving plane can be determined from the phase differences by the phase angle determining unit. The first and/or the second communications participant includes a tracking computer, which is provided with the phase angle for processing, in order to align the first and/or the second communications participant to the signal so that phase differences of zero result, and a calibration device is assigned to the detector arrangement, which is embodied to continuously calibrate the detectors of the detector arrangement.

The invention creates a method for tracking two communications participants of an optical satellite communications system, in particular a satellite (or the optical transmitter unit thereof), and a ground station, to provide a communication connection between the two communications participants. With the method according to the invention, a first of the two communications participants transmits a signal to a second of the two communications participants. The second communications participant comprises a detector arrangement with several, in particular more than three, detectors in a common receiving plane, by which respectively the phase of the signal is acquired, wherein phase differences between the phases are determined by a phase-processing unit. The desired receiving plane is covered by the several detectors. A phase angle of the alignment of the signal to the receiving plane is determined from the phase differences. The phase angle is processed by a tracking computer, in order to align the receiver unit of the respective communications participant to the signal so that the phase difference becomes zero. According to the invention, the detectors of the detector arrangement are continuously calibrated.

In order to ensure an optimum data exchange between the two communications participants, that is, the transmitter as well as the receiver, respectively one such tracking unit is expediently used in the transmitter as well as the receiver.

In this manner a better accuracy compared to the prior art can be achieved in determining the phase angle and the tracking of the two communications participants based on the signal transmitted between them, which optionally is a beacon signal. The improved tracking accuracy can be used in order to use a greater focusing of the transmission beam and to achieve a higher range resulting therefrom or, with the same range, to achieve a saving in terms of the transmitting power required. If the power is used to increase the range, high data rate deep space connections can be realized under these conditions.

For calibration it is necessary to determine the signal delays between the detectors via a calibration signal.

The signal is preferably an optical tracking signal (beacon) generated by the laser in addition to the actual optical communications signal. In particular, it is expedient if the optical tracking signal is a CW (continuous wave) tracking signal. It can furthermore be provided for the optical tracking signal to be transmitted in a multiplex signal, which in addition comprises a communications portion. This signal could then be a signal carrying a code, which with the aid of correlation or autocorrelation functions can be used for an exact determination of the time lag in the time received regarding the respective detectors. This type of signal carrying a code forms the basis of Galileo navigation signals, for example.

Likewise the signal can be a communications signal exchanged between the first and the second communications participants via the optical communication connection. The communications participants hereby have corresponding transmitter and/or receiver units between which the communications signal is exchanged. In this embodiment, the separate tracking signal can be omitted.

In the embodiment variants of determining the phase differences of a tracking signal or of a communications signal, the detectors of the detector unit are provided in addition to the transmitter and/or receiver unit; as mentioned above, at least 3 separate detectors are included.

Based on the wavelengths used in the optical range and the phase inaccuracy resulting therefrom in the transit time difference or path difference which results in an ambiguity, a possibility for eliminating this ambiguity is used. According to an expedient embodiment of this type, the periodicity of the respective phase is eliminated using an FMCW frequency ramp. If the different detectors are tuned to only one step frequency, the different detectors receive the ramp shaped signal at this tuning frequency at different times. If the signal is to be received at only one point in time, the respective detectors then receive the signal at different frequencies. Ideally, with an optimum alignment of the respective terminals to one another, all of the detectors receive the received signal on the same frequency at the same time. The bandwidth of the frequency ramp signal is selected with reference to the Doppler effect to be expected. The detectors are tuned to the center of the step frequency or frequency ramp, so that the possible Doppler effect can be eliminated to the maximum extent with a positive as well as with a negative frequency shift.

Expediently, the determination of the phase differences is carried out in addition to the determination of a maximum amplitude of the signal in order to improve a determination of the phase angle based on this maximum amplitude with the aid of difference signals on the basis of the phase difference. According to this embodiment, the detector arrangement per se is not used solely to determine the phase angle. Instead, a conventional determination of the phase angle is carried out by determining a maximum amplitude of the evaluated signal, the phase angle determined hereby being determined even more accurately due to the additional consideration of respective phase differences.

The invention furthermore creates a system for tracking two communications participants of an optical satellite communications system, in particular a satellite or the optical transmitter unit thereof as well as a ground station, to provide an optical communication connection between the two communications participants. With the system according to the invention, a first of the two communications participants comprises a transmitter unit with which a signal can be transmitted to a second of the two communications participants. The second communications participant comprises a detector arrangement with several detectors in a common receiving plane, through which respectively the phase of the signal can be detected. The second communications participant comprises a phase-processing unit and a phase angle determining unit, wherein phase differences between the phases can be determined by the phase-processing unit and a phase angle of the alignment of the signal to the receiving plane can be determined from the phase differences by the phase angle determining unit. The first and/or the second communications participant comprise a tracking computer, which is provided with the phase angle for processing, in order to align the first and/or the second communications participant to the signal so that phase differences of zero result. The system is characterized in that a calibration arrangement is assigned to the detector arrangement, which is embodied to continuously calibrate the detectors of the detector arrangement.

In order to ensure an optimum data exchange between the two communications participants, that is, the transmitter as well as the receiver, expediently respectively one such tracking unit is used with the transmitter as well as with the receiver.

The system according to the invention has the same advantages as are described above in connection with the method according to the invention. In particular, the system according to the invention renders possible an improved tracking accuracy. The range between the first and second communications participants can be increased due to the possible stronger beam focusing of the signal. In particular, the range can be more than 100,000 km. Alternatively, transmitting power required can be saved due to the improved tracking accuracy if an original distance between the two communications participants is retained. In the latter case, a higher data rate can also be achieved while retaining the transmitting power but at the same time reducing the beam focusing.

Expediently, a transmitter unit and/or a receiver unit is arranged in the receiving plane, the several detectors being arranged around the transmitter unit and/or the receiver unit.

According to a further expedient embodiment, the detector arrangement comprises at least three detectors arranged in a receiving plane, which respectively detect the phase of the signal. The number of detectors can also be more than 3 (three), but this represents a minimum due to the receiving plane to be covered.

It is furthermore expedient if the respective distance between two detectors is selected in the distance of a predetermined accuracy in the determination of the phase differences and to the prevailing environmental influences to be included in the considerations. In general, the distance of the detectors should be selected to be as large as possible (approx. 0.3 m-1 m) with respect to the desired resolution and the real environmental influences.

In a further embodiment, the first communications participant is the satellite, i.e., a transmitter of the communications system, and the second communications participant is the ground station, i.e., a receiver of the communications system. Likewise, the first communications participant could be the ground station and the second communications participant could be the satellite. In particular it is useful for an optimum alignment of the respective terminals to one another for the satellite (transmitter of the communications system) as well as the ground station (receiver of the communications system) to have a detector arrangement according to the invention and the further necessary components for determining the respective difference phases. In this case, both communications participants can be tracked on the communication signal.

Embodiments of the instant invention are directed to a method for tracking between two communications participants of an optical satellite communications system to provide a communication connection between the two communications participants. The method includes transmitting a signal from a first of the two communications participants to a second of the two communications participants, in which the second communications participant includes a detector arrangement with a plurality of detectors in a common receiving plane. The method also includes acquiring a phase of the signal at each of the plurality of detectors and determining phase differences between the phases via a phase-processor, determining from the phase differences a phase angle of an alignment of the signal to the receiving plane, processing the phase angle with a tracking computer in order to align the receiving plane of the second communications participant with the signal, whereby the phase difference becomes zero, and continuously calibrating the plurality of detectors of the detector arrangement.

According to embodiments of the invention, the two communications participants may include a satellite and a ground station.

In accordance with other embodiments, the method can include determining signal delays between the plurality of detectors of a calibration signal for at least a part of the continuous calibrating.

Moreover, the signal can include at least one of an optical tracking signal or beacon generated by a laser and an optical communications signal. The optical tracking signal may include a continuous wave (CW) tracking signal. Further, the optical tracking signal may be transmitted in a multiplex signal including a communications portion.

According to still other embodiments, the signal may include a communications signal exchanged between the first and the second communications participants via an optical communication connection.

In accordance with further embodiments of the invention, using an FMCW (frequency step CW signal) frequency ramp, an ambiguity of the phase difference with respect to 2 Pi and a confinement of the possible measuring range to be corrected can be eliminated.

Further, the determining of the phase differences can include determining a maximum amplitude of the signal in order to improve the determining of the phase angle based on the determined maximum amplitude and determining difference signals on the basis of the phase difference.

Embodiments of the invention are directed to a system for tracking between two communications participants of an optical satellite communications system in to provide a communication connection between the two communications participants. The system includes a first of the two communications participants that includes a transmitter unit structured and arranged to transmit a signal to a second of the two communications participants. The second communications participant includes a detector arrangement with a plurality of detectors arranged in a common receiving plane, such that the plurality of detectors are structured and arranged to respectively detect a phase of the signal, and the second communications participant further includes a phase-processor and a phase angle determiner, such that the phase-processor is structured and arranged to determine the phase differences between the phases and the phase angle determiner is structured and arranged to determine a phase angle of an alignment of the signal to the receiving plane from the phase differences. At least one of the first and the second communications participant includes a tracking computer structured to receive the determined phase angle for processing, in order to align the at least one of the first and the second communications participant to the signal so that the phase difference is zero, and a calibration device is assigned to the detector arrangement that is formed to continuously calibrate the plurality of detectors of the detector arrangement.

In accordance with embodiments of the instant invention, the two communications participants may include one of a satellite or an optical transmitter unit of the satellite and a ground station.

According to other embodiments, the detector arrangement may further include at least one of a transmitter unit and a receiver unit arranged in the receiving plane, and the plurality of detectors are arranged around the at least one of the transmitter unit and the receiver unit.

Moreover, the plurality of detectors can include at least three detectors arranged in the receiving plane, which respectively detect the phase of the signal. A respective distance between two detectors can be selected based on a predetermined accuracy in the determination of the phase differences and to the prevailing environmental influences to be included in the considerations.

According to still other embodiments of the invention, the first communications participant is the satellite and the second communications participant is the ground station.

In accordance with still yet other embodiments of the present invention, the first communications participant is the ground station and the second communications participant is the satellite.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates of a receiver unit to illustrate the concept of tracking in a satellite communications system on which the invention is based; and

FIG. 2 illustrates a plan view of the receiver unit shown in FIG. 1, which shows the arrangement of three detectors by way of example relative to an optical receiver of the receiver unit.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The method according to the invention for tracking two communications participants of a satellite communications system, which is also known as tracking, is based on the evaluation of respective phase differences of a signal received by several detectors of a detector arrangement of a communications participant. The phase differences can be used directly to calculate and subsequently eliminate a phase angle, wherein with an eliminated phase angle, phase difference respectively determined between two of the number of detectors becomes zero.

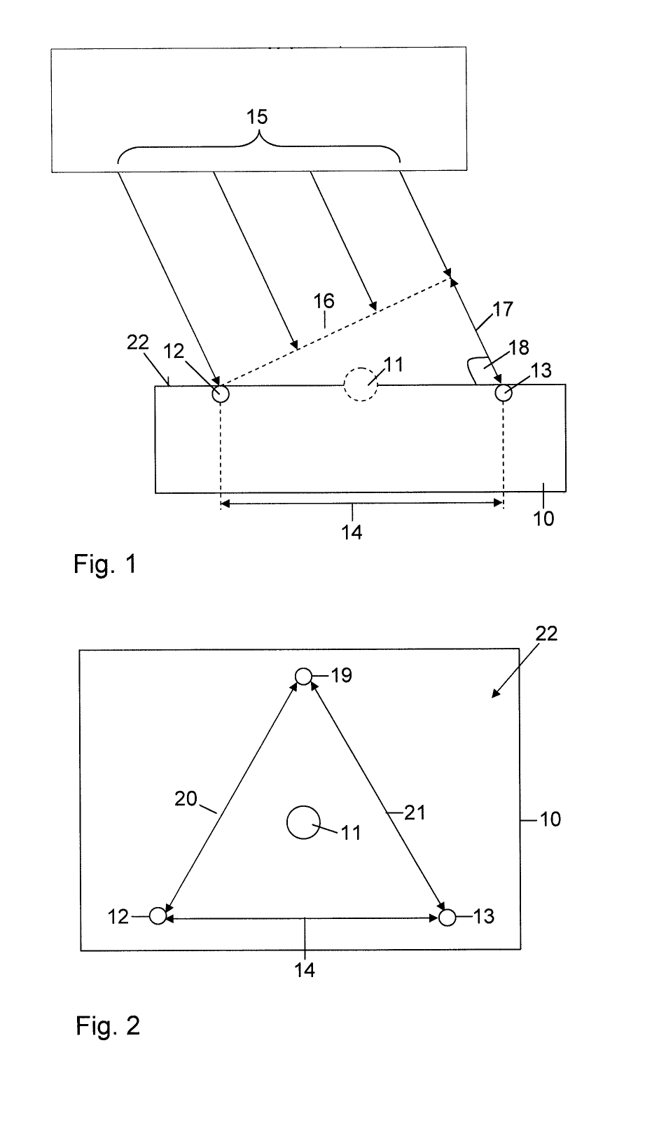

The principle used hereby is explained in detail below based on the diagrammatic representations of FIGS. 1 and 2.

FIG. 1 shows in a cross-sectional representation a receiver unit 10 with two detectors 12, 13 of a detector arrangement discernible in cross section as well as an optional receiver 11, e.g., an optical receiver. FIG. 2 shows receiver unit 10 in a plan view. It is discernible hereby that three detectors 12, 13, 19 are arranged around receiver 11 by way of example at a respectively predetermined distance 14, 20, 21. Detector arrangement can also have more than three detectors, which then are preferably arranged to be distributed around receiver 11. Detectors 12, 13, 19 of the detector arrangement are arranged in a common receiving plane 22.

Receiver unit 10 is provided in at least one of the two communications participants of the satellite communications system. Preferably, receiver unit 10 is embodied in a satellite (not shown). Alternatively or additionally, in order to be able to optimize the performance of the system as a whole, receiver unit 10 can also be provided in a ground station of the satellite communications system.

Receiver unit 10 is used to receive and to evaluate an optical signal 15, which is generated by the other communications participant. The optical signal labeled by reference number 15 is received in conventional tracking systems by receiver 11 and evaluated with respect to its maximum amplitude. Receiver 11 can be composed of a conventional receiver unit, e.g., an optical receiver, which is embodied in the last receiving and tracking stage by an FPA with a number of CCD (charge coupled devices) units. A phase angle can be determined by an evaluation of amplitude maximums of signals received on the CCD units.

In the method according to embodiments, signal 15 first strikes sensor 12 with its wavefront 16 and must additionally cover the path distance 17 before striking detector 13. A phase difference between detectors 12 and 13 results from path distance 17. A respective phase difference can also be determined between detectors 12 and 19 as well as detectors 13 and 19 in a corresponding manner.

If the receiver unit 10 has more than three detectors, a respective phase difference of the signal between respectively two of the number of detectors arranged in receiving plane 22 is determined, which expediently should have a maximum distance from one another.

A phase angle of signal 15 relative to receiving plane 22 can be determined from the respective phase differences. The phase angle is labeled by reference number 18 in the exemplary embodiment of FIG. 1. Phase angle 18 can be used directly to track by a compensatory movement of the communications participant containing the receiver unit 10 or the communications participant transmitting signal 15, when it has carried out the measurement, so that signal 15 strikes receiving plane 22 in a perpendicular manner and the phase differences become zero.

In order to obtain the most precise possible phase differences between respective pairs of sensors, it is provided to calibrate the detectors continuously. For example, a calibration signal for the determination of signal delays between the detectors is used for this purpose. It is likewise expedient to eliminate distortions of the satellite movements by a continuous calibration. Known systems exist for the calibration of the signal transit times of the respective received signals of the different detectors to the receiver and evaluation unit, which are implemented for this purpose. These are based on the emission of a signal by the evaluation unit and subsequent reflection of this signal at the respective detectors. Regarding the vibration movements of the satellite and the correction unit required for this purpose, systems for the correction thereof likewise exist, which are based on the use of acceleration sensors. Atmospheric disturbances can be minimized by such a continuous calibration described, since these are included in the correction of the respective detectors within the scope of the calibration.

To determine the phase differences, e.g., the communication signal exchanged between the communications participants can be used. This is expedient when a very high resolution of the phase differences is desired to be possible as the result of the calculations of correlation functions. With an OOK modulation, the signal can be used directly to determine the phase differences.

In another embodiment, the possibility exists of using a tracking or beacon signal (so-called beacon) transmitted in addition to the communication signal to determine the phase differences, the tracking signal preferably being generated by a laser. The use of a CW (continuous wave) tracking signal may be advantageous. The transmitter unit (e.g., a laser) emitting the tracking signal can be modulated with a multiplex signal that is composed of a communications portion and the tracking portion. This signal could then be a signal carrying a code, which can be used with the aid of correlation or autocorrelation functions an exact determination of the time lag in the received time regarding the respective detectors. A signal of this type carrying a code forms the basis of Galileo navigation signals, for example.

In order to eliminate the periodicity of the phase (lambda/2=3 lambda/2=5 lambda/2 . . . ), it is provided to apply a solution from radar technology: this is known as the FMCW frequency ramp or step technology.

In this context, this is also referred to as FSCW (Frequency Step CW Signal) technology. If different receivers or detectors are tuned to only one frequency step, the different detectors receive the ramp-shaped signals that are tuned to this frequency at different times. The bandwidth of the frequency ramp is selected in relation to a possible Doppler effect. The receiver is tuned to the center of the frequency step so that a possible Doppler effect is eliminated.

The distance between detectors 12, 13, 19 is important for the accuracy of the determination of the phase difference. As an example: with a wavelength of lambda/2=775 nm as a path difference between two detectors separated by a distance of 1 m, this leads to a phase difference angle of 7.75·10⁻⁷ radian=4.45·10⁻⁵°, such that an achievable accuracy of less than 5.7·10⁻²° is achieved. The duration of lambda/2 is 2.68·10⁻¹⁵ seconds.

A very accurate phase measurement is possible hereby, through which the tracking of the two communications participants is possible in an improved manner. As already explained at the outset, the receiver unit 10 shown in the figures can be provided in a satellite as well as in a ground station.

Due to the greater tracking accuracy, it is possible to use a more focused transmission signal and to reduce the beam width of the signal. The transmitter of the signal can hereby be operated at lower power and lower operating costs. On the other hand, with the same power available, a greater distance between the communications participants can be bridged. A so-called deep space communication is hereby possible, in which distances of more than 100,000 km can be bridged.

Since the phase of the signal received by the receiver unit 10 is measured by all the detectors of the receiver unit 10, the influence of a phase distortion due to atmospheric disturbances during reception by the respective detectors under certain marginal conditions, for example, regarding the spatial extent of the system, as well as the chronological measuring space, is the same. Atmospheric disturbances therefore do not have any special effect.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMBERS

10 Receiver unit
11 Optical receiver
12 Detector
13 Detector
14 Distance between detector 12 and 13
15 Signal
16 Wavefront plane with same phase
17 Path difference
18 Phase angle
19 Detector
20 Distance between detector 12 and 19
21 Distance between detector 13 and 19
22 Receiving plane

What is claimed:

1. A method for tracking between two communications participants of an optical satellite communications system to provide a communication connection between the two communications participants, the method comprising:
transmitting a signal from a first of the two communications participants to a second of the two communications participants, the second communications participant comprising a detector arrangement with a plurality of detectors in a common receiving plane;
acquiring a phase of the signal at each of the plurality of detectors and determining phase differences between the phases via a phase-processor;
determining from the phase differences a phase angle of an alignment of the signal to the receiving plane;
processing the phase angle with a tracking computer in order to align the receiving plane of the second communications participant with the signal, whereby the phase difference becomes zero; and
continuously calibrating the plurality of detectors of the detector arrangement.

2. The method according to claim 1, wherein the two communications participants comprise a satellite and a ground station.

3. The method according to claim 1, further comprising determining signal delays between the plurality of detectors of a calibration signal for at least a part of the continuous calibrating.

4. The method according to claim 1, wherein the signal comprises at least one of an optical tracking signal or beacon generated by a laser and an optical communications signal.

5. The method according to claim 4, wherein the optical tracking signal comprises a continuous wave (CW) tracking signal.

6. The method according to claim 4, wherein the optical tracking signal is transmitted in a multiplex signal comprising a communications portion.

7. The method according to claim 1, wherein the signal comprises a communications signal exchanged between the first and the second communications participants via an optical communication connection.

8. The method according claim 1, wherein using an FMCW (frequency step CW signal) frequency ramp, an ambiguity of the phase difference with respect to 2 Pi and a confinement of the possible measuring range to be corrected is eliminated.

9. The method according to claim 1, wherein the determining of the phase differences comprises determining a maximum amplitude of the signal in order to improve the determining of the phase angle based on the determined maximum amplitude and determining difference signals on the basis of the phase difference.

10. A system for tracking between two communications participants of an optical satellite communications system in to provide a communication connection between the two communications participants, the system comprising:
a first of the two communications participants comprising a transmitter unit structured and arranged to transmit a signal to a second of the two communications participants;
the second communications participant comprising a detector arrangement with a plurality of detectors arranged in a common receiving plane, the plurality of detectors being structured and arranged to respectively detect a phase of the signal;
the second communications participant comprising a phase-processor and a phase angle determiner, wherein the phase-processor is structured and arranged to determine the phase differences between the phases and the phase angle determiner is structured and arranged to determine a phase angle of an alignment of the signal to the receiving plane from the phase differences;
at least one of the first and the second communications participant comprise a tracking computer structured to receive the determined phase angle for processing, in order to align the at least one of the first and the second communications participant to the signal so that the phase difference is zero; and
a calibration device assigned to the detector arrangement that is formed to continuously calibrate the plurality of detectors of the detector arrangement.

11. The system according to claim 10, wherein the two communications participants comprise one of a satellite or an optical transmitter unit of the satellite and a ground station.

12. The system according to claim 10, wherein the detector arrangement further comprises at least one of a transmitter unit and a receiver unit arranged in the receiving plane, and the plurality of detectors are arranged around the at least one of the transmitter unit and the receiver unit.

13. The system according to claim 10, wherein the plurality of detectors comprises at least three detectors arranged in the receiving plane, which respectively detect the phase of the signal.

14. The system according to claim 13, wherein a respective distance between two detectors is selected based on a predetermined accuracy in the determination of the phase differences and to the prevailing environmental influences to be included in the considerations.

15. The system according claim 10, wherein the first communications participant is the satellite and the second communications participant is the ground station.

16. The system according claim 10, wherein the first communications participant is the ground station and the second communications participant is the satellite.
